(19) United States
(12) Patent Application Publication
(10) Pub. No.: US 2016/0243544 A1
(43) Pub. Date: Aug. 25, 2016

(54) A DEVICE AND METHOD FOR USING THE DEVICE

(71) Applicant: ABON BIOPHARM (HANGZHOU) CO., LTD., Hangzhou, Zhejiang (CN)

(72) Inventors: Lin Hu, Hangzhou, Zhejiang (CN); Haipeng Hu, Hangzhou, Zhejiang (CN)

(21) Appl. No.: 15/032,412

(22) PCT Filed: Nov. 2, 2014
(86) PCT No.: PCT/CN2014/090144

§ 371 Date: Apr. 27, 2016

(30) Foreign Application Priority Data
Nov. 14, 2013 (CN) 201310566181.X
Nov. 14, 2013 (CN) 201320718994.1

(51) Int. Cl. B01L 3/00

(52) U.S. Cl. CPC B01L 3/5029; B01L 2300/042; B01L 2300/046; B01L 2300/047; B01L 2300/0663; B01L 2300/0672; B01L 2300/044

(57) ABSTRACT

A device comprising a first cavity (300) and a second cavity (400), wherein the first cavity (300) and the second cavity (400) are in a flexible connection; liquid is stored in the second cavity (400) through motion of the relative position of the first cavity (300) and the second cavity (400). The first cavity (300) and the second cavity (400) have a first position and a second position; when the first cavity (300) and the second cavity (400) are in the first position, the relative position of the first cavity (300) and the second cavity (400) is a stationary and immovable device for collecting samples. By using the device and method in the invention, the integrated function for collection and detection of samples can be realized; in addition, the collection device also can realize the function for quantitative sample injection.

### FIELD OF THE INVENTION

The invention relates to a device and method for using the device, in particular to a device for quantitative split-flow of fluid samples and to a method for detection of analyzed substances in samples by using the device.

### BACKGROUND OF THE INVENTION

The following background art is used for helping readers to understand the invention, but not regarded as the prior art.

In our society, abuse of illegal drugs has become an acknowledged and deteriorating social problem. In 2003, the survey made by the Department of Health and Human Services (HHS) found that about 19.5 million Americans for 8.2% of population above 12 years old is taking illegal drugs. “Recently used illegal drug” was an illegal drug had been using within one month prior to the survey made by HHS. Marijuana was found to be the most commonly used illegal drug, accounting for 6.2% of drugsters (14.6 million). It was estimated that 2.3 million (1.0%) people were using cocaine, 604,000 people used crack, 1 million people were using hallucinogens, and 119,000 people were using heroin.

The United States Patents US2004/0184954 and US2004/0237674 disclose other devices for collecting saliva and detecting whether illegal drug ingredients are contained in the saliva. Both the patents provide devices and methods for collecting and detecting saliva. In these devices, after samples are collected into a collector, external force is applied to squeeze the samples in an absorber on the collector into a collection cavity for detection. However, when the sample collector and the collection cavity are in a cooperating extrusion, operators may touch samples, thus causing pollution or infection; besides, such collection devices are inconvenient under the condition that samples need blending with buffer solution prior to detection.

In addition, in some detection, samples need processing prior to detection. For example, buffer solution is added into samples for dilution so as to reduce viscosity and consistency of the samples, thus guaranteeing smooth dialysis of the samples on a detection bar. Such problems shall be solved as how to successfully and fully blend buffer solution with sample for convenient operation. In other detection, in order to guarantee the detection accuracy, the size of samples detected shall be quantitative so as to prevent too small sample size from failure of detection and prevent too large sample size from resulting in flooding thus influencing the accuracy of the detection results. Therefore, better methods and devices are required for collection and detection of samples.

### SUMMARY OF THE INVENTION

The invention provides a new device, which not only can ensure quantitative fluid samples are stored in a cavity but also can control fluid samples of appropriate volume stored in the cavity to be released for detection of substances analyzed at different opportunities and under different conditions. In particular, such a device can be either integrated with a detecting element into a whole or separated from the detecting element, available for meeting different detection requirements. In some preferred embodiments, the device can ensure samples being collected are fully blended with buffer solution. More preferably, relevant detection can be made while samples are collected. In addition, the device is simple and convenient for use by operators.

On one hand, the invention provides a device for detecting substances analyzed in fluid sample, wherein the device includes a first cavity and a second cavity, wherein the first cavity and the second cavity are in a flexible connection; fluid is stored in the second cavity through motion of the relative position of the first cavity and the second cavity.

Preferably, the fluid is quantificationally stored in the second cavity.

Preferably, the first cavity and the second cavity have a first position and a second position; when the first cavity and the second cavity are in the first position, the relative position of the first cavity and the second cavity is stationary and immovable. Preferably, when the first cavity and the second cavity are in the second position, the relative position of the first cavity and the second cavity is movable (relatively mobile). Preferably, the second cavity includes a seal cavity that can be sealed by a potted element; when the first cavity and the second cavity are in the first position, the opening of the seal cavity can be sealed by the potted element, thus forming a seal cavity. Preferably, when the first cavity and the second cavity move from the first position to the second position, the volume of the seal cavity is gradually reduced.

Preferably, when in the first position, the first cavity and the second cavity are fixed by a snap buckle structure and immovable. Preferably, the snap buckle structure is removed when the first cavity and the second cavity move from the first position to the second position, or only after the snap buckle structure is removed can the first cavity move from the first position to the second position. Preferably, the distance between the first position and the second position is restricted by the snap buckle structure, or the distance moving from the first position to the second position is limited by the snap buckle structure.

Preferably, a potted element compresses the seal cavity, thus reducing or gradually reducing its volume. Preferably, the potted element also includes an absorber element connected with the potted element into a whole and used for absorbing fluid samples. Preferably, when the first cavity and the second cavity are in the first position, the absorber element is positioned in the seal cavity that can be sealed. Preferably, when the first cavity and the second cavity move from the first position to the second position, the potted element moves together with the absorber element and compresses the absorber element. In other words, the seal cavity and the absorber element inside are sealed and then compressed.

Preferably, the first cavity or the second cavity internally includes a solution reagent bag structure pierceable. Preferably, the potted element includes a puncture component which can pierce the bag structure from which solution reagent is released. Preferably, the second cavity is internally provided with symmetrical lock slots for placing the bag structure filled with solution reagent.

Preferably, the potted element also includes a detecting element which is communicated with absorber element fluid through a channel. Preferably, a collection rod connects the potted element to the detecting element; one end of the collection rod is connected with the potted element, while the other end is connected with the detecting element. Preferably, the channel is positioned in the collection rod, and the puncture component is positioned on part of the collection rod between the detecting element and the absorber element. Preferably, before the potted element seals the seal cavity, the puncture component positioned on the collection rod has pierced the bag structure. Preferably, when the first cavity and the second cavity move from the first position to the second position, a part of fluid samples in the seal cavity is forced to pass through the channel and contact with the detecting element.

Preferably, the first cavity is connected with the second cavity through a screw thread.

The invention also provides a device including a collection cavity, wherein, the collection cavity is a split-type structure, including a first cavity and a second cavity; the first cavity and the second cavity are in a flexible connection; fluid is stored in the second cavity and quantitative fluid is released from the second cavity through motion of the relative position of the first cavity and the second cavity. By virtue of the split-type structure of the collection cavity and change of position between the first cavity and the second cavity, a certain amount of sample can be collected and sent to the detecting element, simultaneously, the sample is fully blended with buffer solution for detection, thus ensuing the detection effectiveness.

Preferably, change of mutual position of the first cavity and the second cavity can ensure the sample to be collected in the second cavity. Further, sample in the second cavity can flow onto the detecting element communicated with the second cavity, thus realizing integration of collection and detection.

In an embodiment, the first cavity has a first position and a second position on the second cavity. In a preferred embodiment, when the first cavity is in the first position, the second cavity is sealed by the potted element, thus forming a seal cavity. By virtue of the seal cavity a certain amount of sample can be ensured to enter into the chamber, thus realizing the quantitative function of samples.

In another preferred embodiment, when the first cavity rotates from the first position to the second position, the volume of the seal cavity is reduced because the rotation drives the potted element to move in the seal cavity. Fluid is collected into the seal cavity, and a certain amount of (for example, an expected fluid volume) fluid flows out of the seal cavity. As the size of the second cavity sealed is fixed, the size of samples collection is also fixed; in addition, when the first cavity rotates on the second cavity to the second position, the reduced volume of the seal cavity is also fixed, thus a fixed amount of sample is released.

In an embodiment, when the first cavity is in the first position, the first cavity and the second cavity are fixed a snap buckle; when the first cavity is in the second position, the snap buckle is removed and both cavities are at movable and rotatable status. In other words, when the first cavity is in the first position, the first cavity and the second cavity are fixed the snap buckle, thus position of both cavities are fixed and they are unable to move; after the snap buckle is removed, the first cavity and the second cavity are able of relative motion.

In an embodiment, the device also includes a sample collector; the sample collector includes a second potted element for sealing the seal cavity, and a first potted element for covering and sealing the opening of the first cavity.

In a preferred embodiment, when the first cavity is in the first position, the collector as well as the first cavity and the second cavity are sealed by the first potted element and the second potted element, and the absorber element of the collector is positioned in the second cavity sealed. The collector is provided with an absorber element used for collecting samples for detection; the top of the absorber element is provided with a second disc and gasket for sealing the second cavity by matching to the second cavity side wall (as an embodiment of the second potted element); besides, the collector is also provided with a first cylinder forming sealing with the first cavity side wall (as an embodiment of the first potted element).

In this way, the first cavity is connected with the collector into a whole, capable of moving relative to the second cavity. In another preferred embodiment, when the first cavity rotates from the first position to the second position, the sample collector moves along the second cavity together with the first cavity, and the absorber element of the sample collector is compressed by the second cavity sealed; sample on the absorber element flows into the second cavity sealed. Preferably, fluid sample flows into the seal cavity of the second cavity, or a certain amount of fluid in the second cavity is released out of the seal cavity and contacts with the detecting element.

In an embodiment, on the first cavity the sample collector has a third position and fourth position.

In another preferred embodiment, the sample collector includes symmetrical puncture components; the second cavity is internally provided with symmetrical lock slots for placing an aluminum foil bag filled with buffer solution. In an embodiment, the second cavity is provided with four symmetrical lock slots; an aluminum foil bag is arranged between every two lock slots. To be specific, when the sample collector is positioned in the collection cavity and the puncture component of the collector is positioned between the lock slots, the puncture component can touch and pierce the aluminum foil bag in the lock slots. Therefore, the sum of the longitudinal length of symmetrical puncture components shall be less than or equal to the diameter of the sample collection cavity, and greater than the straight-line distance between every two lock slots.

In an embodiment, when the sample collector covers the collection cavity, the collector is in the third position of the first cavity, and the puncture component of the collector is in the second cavity where there is no aluminum foil bag.

In another embodiment, when the sample collector is in the fourth position of the first cavity, the puncture component touches and pierces the aluminum foil bag. In other words, when the sample collector is in the fourth position, the puncture component on the sample collector is positioned within the area of lock slots. More specifically, the center of the lock slot on the second cavity and the fourth position of the first cavity are in a straight line; thus, it can be ensured that, when the sample collector is in the fourth position of the first cavity, the puncture component on the sample collector is just in the center of lock slots, i.e., the center of the aluminum foil bag, thus ensuring the aluminum foil to be pierced by the puncture component.

In a preferred embodiment, when the sample collector is rotated to the third position, the sample collector, the first cavity and the second cavity form seal.

In an embodiment, the device also includes a detecting element; the detecting element is positioned on the sample collector and communicated with sample collector fluid.

More specifically, the detecting element is communicated with the sample collector through hollow collection rod fluid.

In a preferred embodiment, when the first cavity rotates from the first position to the second position, sample sealed in the second cavity flows onto the detecting element through the collection rod. In other words, fluid sample flowing from the absorber element into the sealed second cavity flows onto the detecting element along the hollow collection rod, thus completing the detection. As the sealed space has a fixed volume, the volume reduces and air pressure increases if the sealed space is compressed, the air pressure increased forces fluid to flow out of the space compressed along the collection rod. When the first cavity reaches the second position of the second cavity, the amount of fluid flowing out is also fixed as the space compressed is fixed, thus ensuring a certain amount of fluid flowing onto the detecting element, and realizing the function of quantitative sample injection.

In some embodiments, the first cavity is in threaded connection with the second cavity. Mutual rotation of the first cavity and the second cavity is realized through a corkscrew mode.

In other embodiments, the sample collector is in screwed connection with the first cavity of the collection cavity. Likewise, the sample collector covers and seals the first cavity through a corkscrew mode.

On the other hand, the invention also provides a method for collecting samples, including to provide a device for collecting samples; the device includes a split-type collection cavity, a first cavity and a second cavity, and a sample collector; wherein, on the first cavity the sample collector has a third position and a fourth position; the sample collector is inserted into the collection cavity and covers the third position of the first cavity.

In a preferred embodiment, the sample collector rotates from the third position to the fourth position, and the puncture component on the sample collector pierces the buffer solution aluminum foil bag in the lock slot positioned inside a lower cavity.

In another embodiment, the sample collector rotates from the fourth position to the third position, and the sample collector seals the first cavity and the second cavity in the collection cavity.

In an embodiment, on the second cavity the first cavity has a first position and a second position; on the second cavity the first cavity rotates from the first position to the second position so as to reduce the sealed space of the sealed second cavity and compress the absorber element inside the second cavity; and fluid on the absorber element flows into the sealed second cavity.

In another embodiment, when on the second cavity the first cavity rotates from the first position to the second position, fluid in the seal cavity flows through the hollow collection rod into the detecting element positioned on the top of the collector.

On the other hand, the invention provides a method, including: to provide a device, the device includes a first cavity and a second cavity, wherein the first cavity and the second cavity are in a flexible connection; fluid is stored in the second cavity through motion of the relative position of the first cavity and the second cavity.

Preferably, the first cavity and the second cavity have a first position and a second position; when the first cavity and the second cavity are in the first position, the relative position of the first cavity and the second cavity is stationary and immovable, or the relative position of the first cavity and the second cavity is stationary and immovable when the first cavity and the second cavity are in the second position.

Preferably, when in the first position, the first cavity and the second cavity are fixed by the snap buckle structure and immovable; or the snap buckle structure is removed when the first cavity and the second cavity move from the first position to the second position; or the distance between the first position and the second position is restricted by the snap buckle structure.

Preferably, the second cavity includes a seal cavity that can be sealed by a potted element; when the first cavity and the second cavity are in the first position, the opening of the seal cavity can be sealed by the potted element, thus forming a seal cavity. Preferably, the potted element also includes an absorber element connected with the potted element into a whole and used for absorbing fluid samples. Preferably, when the first cavity and the second cavity are in the first position, the absorber element is positioned in the seal cavity that can be sealed. Preferably, when the first cavity and the second cavity move from the first position to the second position, the potted element moves together with the absorber element and compresses the absorber element.

Preferably, the first cavity or the second cavity internally includes a solution reagent bag structure pierceable; the puncture component on the potted element pierces the solution reagent bag structure when the absorber element is inserted to the seal cavity.

Preferably, before the potted element seals the seal cavity, the puncture component has pierced the bag structure.

Preferably, the puncture component is positioned on a collection rod connecting the absorber element to the detecting element, and the potted element is connected to the absorber element.

In all above-mentioned embodiments, the distance (between the first cavity and the second cavity) limited by snap buckle can be set randomly. Also, the quantity of snap buckle structures can be set as required (1-5), each snap buckle structure is limited at a distance of 1-5 mm or 0.5-1 cm, or each snap buckle structure is limited at different distances, 0.5 mm, 5 mm or 1 cm. Thus, the distance between the second position and the first position between the first cavity and the second cavity is variable, i.e., the compressed space of the seal cavity in the second cavity is also variable, or compressed time after time and step by step, thus realizing repeated quantitative sample injection and multi-detection of the same sample. Also, sample injection and detection are controllable by set one or a plurality of snap buckles; samples can be collected in advance, and the snap buckle is removed for detection if necessary.

### Beneficial Effect

By using the device and the method in the invention, both buffer solution and sample can be fully blended, the integrated function for collection and detection of samples can be realized; in addition, the collection device also can realize the function of quantitative sample injection.

### BRIEF DESCRIPTION OF THE DRAWINGS

FIG. 1 is an exploded view of a device for collecting samples in the invention;

FIG. 2 is a schematic diagram of a component (the second cavity) of the device in the invention;

FIG. 3 is a schematic diagram of how to assembly the second cavity into a collection cavity;

FIG. 4 is a vertical view of the collection cavity (provided with a buffer reagent aluminum foil bag) of the device in the invention;

FIG. 5 is a location diagram of the puncture component in the collection cavity when the collector is in the third position of the collection cavity (the first cavity);

FIG. 6 is a location diagram of the puncture component in the collection cavity when the collector is in the fourth position of the collection cavity (the first cavity);

FIG. 7 is a schematic diagram of the first position of the device in the invention after the collector is integrated with the collection cavity;

FIG. 8 is a sectional drawing of the device in FIG. 5;

FIG. 9 is a schematic diagram of the collection device from which the snap buckle is removed;

FIG. 10 is a schematic diagram of the invention when the first cavity of the device is in the second position of the second cavity;

FIG. 11 is a sectional drawing of the device in FIG. 8.

### REFERENCE NUMBERS IN THE ATTACHED DRAWINGS

Sample collector 100; absorber element 101; seal cylinder 108 (can be used as an opening 408 used for sealing the seal cavity 402 by the second potted element) connected to the absorber element; gasket 102; hollow collection rod 104; channel 50; puncture component 103; cylinder 107 (can be used as the first potted element) above the collection rod; gasket 106; screw thread 105 above the cylinder 107; through hole 109 positioned on the cylinder 108 and communicated with collection rod channel; detecting element 200; test strip 201; device 700; first cavity 300; sampling mouth 301 of the first cavity; plug 302; screw thread 303 positioned in the first cavity and matched to the collector; opening 308 of the first cavity; internal thread 304 of the first cavity; third position 311 on the first cavity of the collector; fourth position 312 on the first cavity of the collector; second cavity 400; external thread 401 of the second cavity; lock slot 403 inside the second cavity; seal cavity 402 sealable; buffer solution aluminum foil bag 500 pierceable; snap buckle structure 600; seal cavity opening 408; third cavity 409; fluid sample 10.

### DETAILED DESCRIPTION

Further description is made as below regarding structures involved in the invention and technical terms used. In the following detailed description, text reference in drawings is a constituent part for illustration of feasible embodiments of the invention. Other feasible embodiments of the invention shall be not excluded, and alteration of structure of the invention is permissible within the scope of use of the invention.

### Sample Collector 100

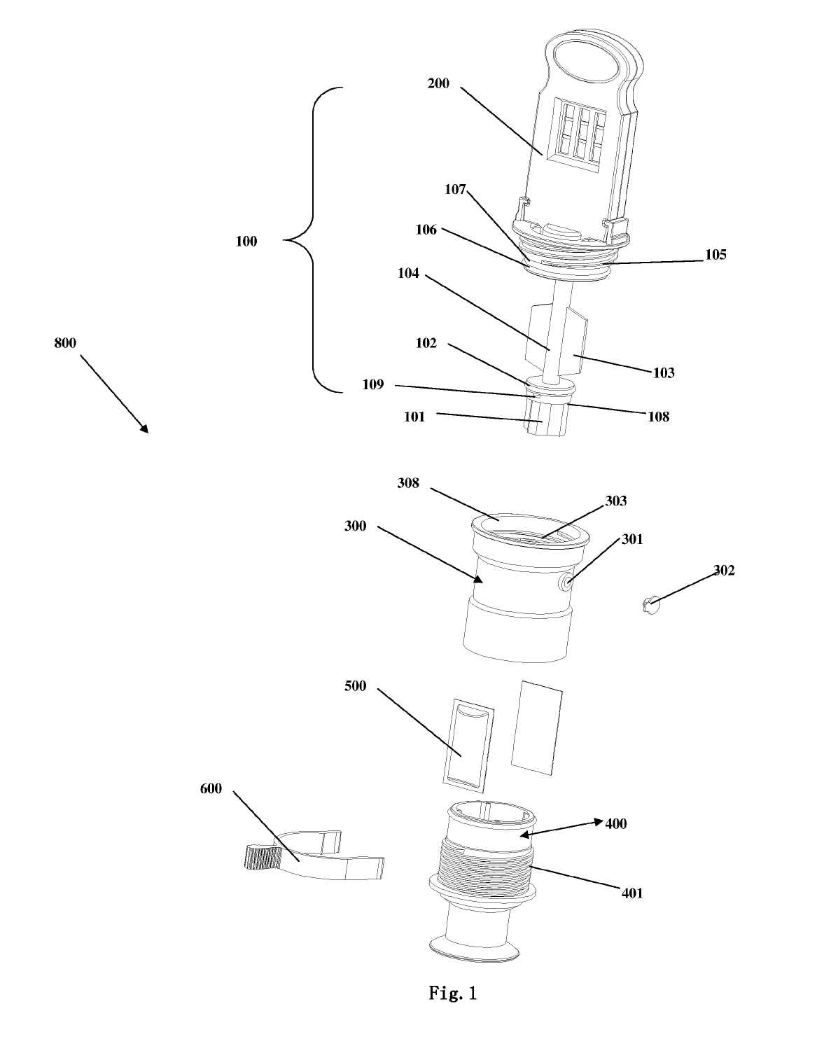

The invention also provides a sample collector 100. Generally, the sample collector 100 comprises an absorber element 101 and a collection rod 104; the absorber element 101 is located at one end of the collection rod 104, as shown in FIG. 1, and the collection rod is connected to the absorber element via a cylinder 108. The cylinder 108 generally comprises a gasket 102 so as to tightly seal the collection cavity. Preferably, the cylinder 108 and the seal gasket 102 thereon can serve as the cavity of the collection cavity sealed by the potted element. Detailed description of such a collector is made in a Chinese Patent for Invention (application number: 201010566805.4). All embodiments in the Chinese Patent for description of the sample collector serve as a portion of the invention, and serve as some embodiments of the collector in the invention. In an embodiment, the other end of the collection rod 104 of the sample collector 100 is connected with a detecting element 200, as shown in FIG. 1, and also communicated with the detecting element 200 fluid via the collection rod 104. In more specific embodiments, the collection rod 104 is a hollow structure, also, the cavity of the collection rod 104 is communicated with the detecting element 200; and the cavity of the collection rod is also communicated with the absorber element 101. In another embodiment, the cylinder 108 above the absorber element is provided with a through hole 109, the through hole 109 is also communicated with the cavity of the collection rod 104, for the convenience of circulation of fluid in the cavity of the collection rod. This is because the through hole 109 play a role in excluding surplus air. The absorber element 101 generally made from medical-grade sponge or foamed plastic frequently-used in the field. However, many other materials can also be used to manufacture the absorber element, for example, cotton or paper, or any other material with water absorption. The collection rod 104 generally is rigid, in favor of operation of the absorber element 101. The collection rod 104 can be made from such materials frequently-used in the fields as plastics, timbers, metals or paperboards. In order to tightly seal the collection cavity, a cylinder 107 is arranged between the collection rod 104 and the detecting element 100 and a gasket 106 is positioned on the cylinder 107. In some embodiments, the collection rod 104 of the collector also includes a puncture component, for example, a puncture component 103; the puncture component can pierce such containers containing solution reagents as aluminum foil bags, bubble-cap bags and plastic bags, these containers can be easily pierced. As shown in FIG. 1, there are two puncture components symmetrically arranged on the collection rod 104. In more specific embodiments, both the puncture component 103 and the detecting element 200 are on the same plane.

### Detecting Element

“The detecting element” can be any testing apparatus available for providing detectable results. In some embodiments, the detecting element is a test strip (for example, a test strip of transverse flow). The test strip has specific binding molecules fixed on the test strip and a reagent for immunodetection. In other embodiments, the detecting element can be a test reagent based on chemical reaction, or a test reagent based on biology (for example, enzyme or ELISA), or a test reagent based on fluorescence, etc. In addition, in some other embodiments, the detecting element has some other reagents which are available for detecting whether the detected sample contains analytes or detecting the amount of analytes. In an embodiment, the detecting element contains a reagent for detecting drug abuse. However, in other embodiments, the detecting element can be any element specified by those who provide test results. For example, some chemical or biological indicators and reagents can be used.

When the detecting element is a test strip, it can include absorbent substrate (such as nitrocellulose) and/or other applicable materials. The substrate can have a sample loading area, a reagent or label area and a detection area. These test strips are widely known in the field. Those of ordinary skill in the art can realize, by reference to the public transcript, that these test strips can be used as test strips in the invention. In some embodiments, the sample loading area is located at one end of a test strip so as to apply the sample to the test strip. Reagents for testing or adjusting samples can also be located in the sample loading area, or positioned in a separate reagent area or label area on the test strip. These reagents can be used for various purposes, for example, for preparing samples for realizing ideal combination with specific binding molecules, or for improving the stability of analytes.

The sample containing analytes detected by the device can be any fluid sample. Fluid samples suitable for testing by using the invention include oral cavity fluid, saliva, whole blood, serum, blood plasma, urine, spinal fluid, biological extracts, mucus and tissue. “Saliva” refers to sialaden secretions. “Oral cavity fluid” refers to any fluid in the oral cavity.

The analyte can be any analyte, and the detecting element can be made for the analyte. In one embodiment, the analyte is a drug of abuse. Other examples of the analyte include hormones, proteins, peptides, nucleic acid molecules, pathogenic reagents and specific bond pair component. “Drug of abuse” (DOA) is a drug for non-medical purposes (usually for psychedelic effects). Abuse of this drug may lead to physical and mental harm, and (in some cases) dependence, addiction, and even death. Examples of DOA include cocaine, amphetamines (e.g. black beauties, white bennies, benny, dextroamphetamines, dexies, beans), methylamphetamines (crank, methylbenny, crystal, speed), barbiturates (diazepam Valium®, Roche Pharmaceuticals, Nutley, N.J.), sedatives (i.e. sleeping pills), lysergic acid diethylamide (LSD), sedatives (downers, goofballs, barbs, blue devils, yellow jackets, ludes), tricyclic antidepressants (TCA, such as imipramine, amitriptyline and doxepin), phencyclidine (PCP), tetrahydrocannabinol (THC, pot, dope, hash and weed, etc.), and opiates (such as morphine, opium, codeine, heroin and oxycodone).

### Device

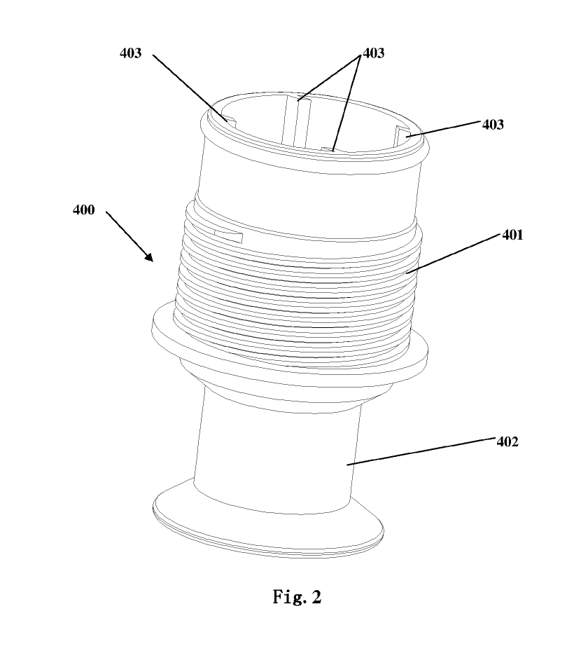

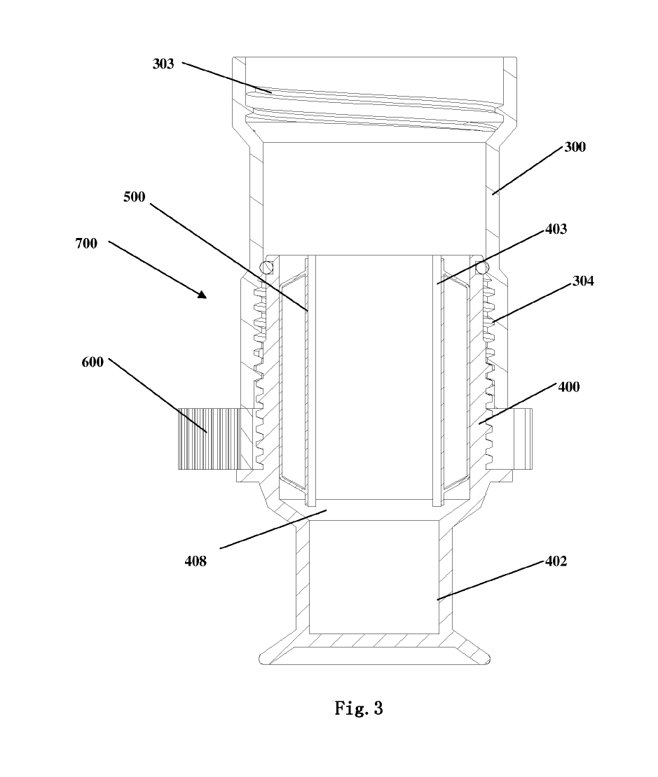

Generally, a cavity 700 is used for receiving fluid samples from the absorber element on the sample collector or from other carriers (e.g. cotton swabs) or directly obtained from other organisms. Generally, the collection cavity is enclosed by side walls and bottom, having an opening for receiving samples. In a preferred embodiment, in order to realize the function of quantitative sample injection of fluid sample, the collection cavity is a split-type structure, i.e. consists of two cavities: a first cavity 300 and a second cavity 400, as shown in FIGS. 2 and 3. “Quantitative sample injection of fluid sample” mentioned here refers to relatively constant volume of fluid sample to be detected, in other words, the volume of sample received every time by different collection cavities remain basically constant; the relatively constant volume can be 1, 2, 3, 4 or 10 ml, set randomly according to different requirements. In addition, the term “quantitative sample injection of fluid sample” also means that, in the same device, fluid sample (5-10 ml) collected at a time can be quantificationally released from the cavity by several times for detection for different purposes; the amount of sample taken every time can be set randomly, for example, 100 ml taken at the first time, and 150 ml at the second time. Detailed illustration is made in following embodiments. “Sample injection” refers to contact between samples and the detecting element in a certain way, thus allowing detection of a portion of fluid sample. Fluid sample can be either injected without preprocessing or preprocessed by certain solution reagent (e.g. buffer solution) prior to detection. “Sample injection” also refers to ejection of sample out of the seal cavity or transmission of sample by other means to the device for analysis, assay or other treatment.

More specifically, the first cavity and the second cavity are in a flexible connection, the function of collection or/and extrusion (extrusion or extraction of sample from the absorber element, or processing of fluid sample by using reagent solution) of sample or/and quantitative sample injection of fluid sample can be realized through motion of the relative position of the first cavity and the second cavity. In some other embodiments, sample shall be fully blended with buffer solution or the absorber element contacts with buffer solution prior to necessary detection. Therefore, sample can be set unavailable for collection or sample injection prior to fully blending with buffer solution. This can be realized by changing the relatively stationary position of the first cavity and the second cavity to changeable relative position. Change of the relative position can be set in such a way as below: the first cavity and the second cavity are in a relatively stationary position, and then changed to a connection relation of relative motion. Such a connection relation of motion can be either an up-and-down relative motion or a button-on relative motion. Anyway, the first cavity and the second cavity are connected to each other; the position of a separate component (e.g. the second cavity) can be changed relative to the first cavity, or the position of the first cavity can be changed on the second cavity.

In an embodiment, a snap buckle structure 600 is arranged at the junction between the first cavity 300 and the second cavity 400; the snap buckle structure 600 ensures the position of the first cavity on the second cavity relatively constant. The first cavity becomes a status of relative motion when the snap buckle structure is removed. This is more convenient for operators: the snap buckle structure 600 is positioned above the first cavity if it is necessary to fix the first cavity; the snap buckle structure 600 is removed if it is necessary to rotate the first cavity. In addition to snap buckle structure, other structures can also realize such function, for example, the second cavity is firstly located in a relatively stationary position via locking, piston type, plug type, bonding, stickup and socketing, etc. The first cavity is fixed on the second cavity, or the second cavity is fixed on the first cavity, or the relative position of the first cavity and the second cavity is stationary. Then these structures are eliminated or changed, the position between the second cavity and the first cavity is changed to status of relative motion, the first cavity can move on the second cavity, or the position of both cavities is changed.

The first cavity and/or the second cavity are changed from a relatively stationary status to a relatively movable status, thus realizing quantitative sample injection of fluid sample; or separation of fluid sample for different purposes (for detection or further treatment, or for confirmation of separation of different samples to be detected, the separation can be achieved simultaneously or step by step) or quantitative sample injection of fluid sample can be completed during or before motion of the relative position of the first cavity and the second cavity; quantitative sample injection of fluid sample is achieved in the seal cavity, or fluid allotted is transferred from the seal cavity to other places (for example, transferred to the device including the detecting element, or directly transferred to the detecting element). Of course, fluid sample can also be transferred from the seal cavity to other devices for analysis and processing, etc. The above-mentioned steps can be completed simultaneously or step by step during the motion of the first cavity and the second cavity. For example, in some embodiments, the second cavity 400 is also provided with a seal cavity 402 through which the function of quantitative sample injection can be realized; i.e., a certain amount of air is in the confined space, fluid in the seal cavity 402 quantificationally flows into the detecting element 200 when air in the confined space is compressed, thus realizing the function of quantitative sample injection. In this way, at least two steps (quantitative sample injection and contact detection of fluid sample) are simultaneously completed. The amount of fluid sample injection can be accurately controlled by controlling the movement distance of the relative position of the first cavity and/or the second cavity. For example, the potted element is integrated with the first cavity or the second cavity into a whole at some time, in this way, the potted element can move together with the first cavity relative to the second cavity, or the potted element can move together with the second cavity relative to the first cavity. For example, in some embodiments, as shown in FIG. 3, the first cavity 300 is connected with the second cavity 400 via a matching screw thread, while the snap buckle structure 600 encircles and is stuck on the first cavity and the second cavity, thus blocking or limiting the screw thread of a certain distance. When in the initial position, the second cavity and the first cavity are in a relatively stationary position as they are limited by the screw thread or the snap buckle structure. At this moment, if the seal cavity 402 sealable is filled with fluid sample, the seal cavity is at a sealed status after the opening of the seal cavity is sealed (for example, sealed by a potted element). The snap buckle structure is removed if it is necessary for quantitative sample injection, at this moment, the first cavity and the second cavity are at a movable status; by mutual rotation the first cavity moves downward relative to the second cavity until the whole screw thread is used up; in the process of rotation, the first cavity drives the potted element to move together, in this way, the volume of the seal cavity is compressed, thus realizing quantitative sample injection for testing. In an embodiment, the second cavity is connected with the first cavity via thread engagement.

In other embodiments, there is one or a plurality of snap buckle structures, and each snap buckle structure limits one distance, in this way, samples with different quantitative volumes can be obtained intermittently by removing snap buckle structures selectively. Preferably, these snap buckle structures are arranged in sequence and conveniently removed from the collection device. In this way, the collection cavity can meet different needs, for example, irregular sample injection, use or detection of different fluid samples for different purposes. The device connecting with the fluid sample and the second cavity can be separately used, for example, used by connecting with an extra device for holding the detecting element; when it is necessary for detection, the collection cavity is connected to the device equipped with the detecting element so that the seal cavity is communicated with the detecting element, thus allowing a portion of fluid sample to flow from the seal cavity onto the detecting element. If the detecting element needs more fluid sample (for example, there are many detecting elements, or detection is made in different time), the number of the snap buckle structure can be continued reducing so that the potted element used for sealing the seal cavity is further compressed at a certain distance in the seal cavity, thus ensuring more fluid samples to contact with a plurality of detecting elements. In this way, one sample can be repeatedly used. For example, after a certain amount of fluid sample is sealed in the seal cavity, and when the detecting element connected and inserted to the device only requires 50 μL sample for detection, the snap buckle is removed at a distance representing 50 μL sample, then the first cavity drives the potted element to move in the seal cavity a certain distance (e.g. 5 mm). For example, after a certain amount of fluid sample is sealed in the seal cavity, and when the detecting element connected and inserted to the device only requires 50 μL sample for detection, the snap buckle is removed at a distance representing 50 μL sample, then the first cavity drives the potted element to move in the seal cavity a certain distance (e.g. 5 mm). For example, after detection of 1-2 analytes is completed by the detecting element connected to the collection cavity, the detecting element is removed, and then the collection cavity is connected to other detecting elements for detection of other (one or a plurality of) analytes. In this way, in addition to sampling, quantitative samples can be obtained; in addition, when in sample injection, depending on the circumstances, the volume of sample injection may be different, which can be regarded as embodiments of “quantitative sample injection”.

The absorber element can be compressed after the opening of the seal cavity is sealed by the potted element; the degree of compression of the absorber element can be controlled by removal of the snap buckle structure. For example, when the opening of the seal cavity is sealed by the potted element, the absorber element is in the seal cavity, but not compressed. At this time, the seal cavity is sealed to be a relatively independent space. At this moment, the first cavity and the second cavity can process a first stationary position. When it is necessary for sampling, a portion of the snap buckle structure is removed, and the first cavity moves relative to the second cavity so that the seal cavity is compressed by the potted element, thus compressing the absorber element in the seal cavity. Of course, in some other embodiments, above-mentioned embodiments are applicable for processing of the absorber element or sample by solution reagent. For example, when solution reagent contacts with the absorber element, the potted element may not seal the seal cavity 402; after the opening of the seal cavity 402 is sealed by the potted element, the absorber element may not be compressed, and can be controlled by the snap buckle structure so as to control the moving distance of the potted element in the seal cavity, thus allowing the absorber element to be compressed step by step (or compressed at one go). In above two embodiments, if surplus fluid sample is separated by the potted element outside the seal cavity (e.g., in a third cavity 409 or the first cavity), the fluid sample can be used for follow-up detection. Detailed description is made as below.

Of course, the detecting element can be integrated with the potted element into a whole; when potted element is moving in the seal cavity, the detecting element is in fluid communication with the seal cavity.

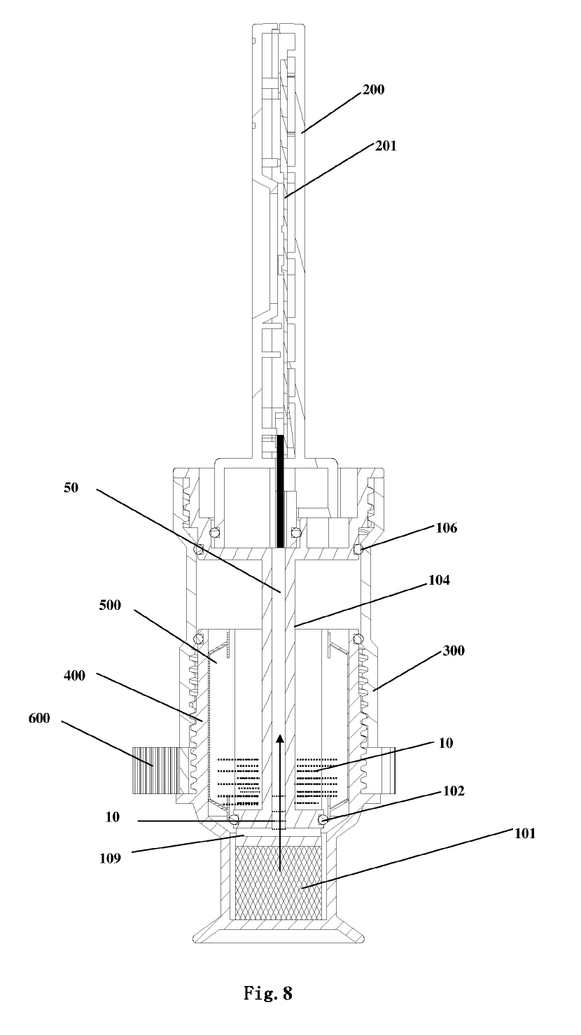

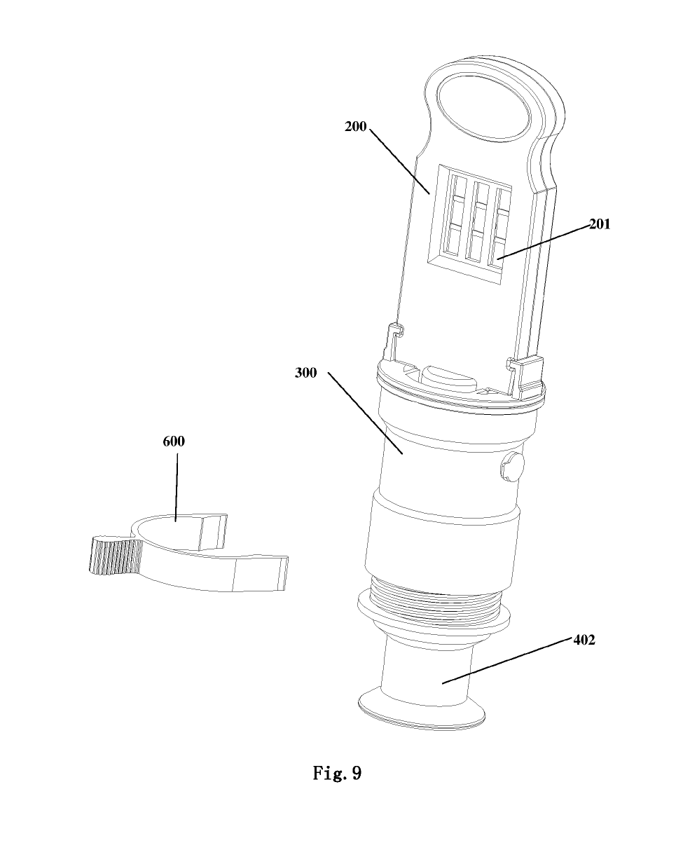

As opening of the seal cavity is sealed by the potted element, the second cavity can be divided into two relatively independent cavities; fluid inside the cavity can be used for detection, while fluid outside the cavity can be used for confirmation of detection in the next step (as shown in FIG. 8). In some embodiments, detection results of sample shall be reinspected for confirmation. Therefore, the first cavity 300 is also provided with a sampling mouth 301 and a plug 302 for sealing the sampling mouth 301. Surplus sample is taken out of the collection cavity 700 through the sampling mouth 301 for reinspection for confirmation.

In some other embodiments, the collection cavity also includes fluid sample processing reagent solution for preprocessing sample. In some embodiments, the second cavity 400 of the device is designed with a structure capable of containing the processing reagent solution. In an embodiment, the structure is a lock slot 403. As shown in FIG. 2, four lock slots 403 on the second cavity are symmetrically positioned on the sidewall of the cylindrical second cavity 300. The lock slot is provided with buffer solution bags, e.g., aluminum foil seal bags in which processing reagent solution is filled. In some embodiments, the seal bags can be easily pierced. In some preferred embodiments, when the opening of the seal cavity is not sealed by the potted element, the reagent solution contacts with the fluid sample or the absorber element absorbed with fluid sample; the reagent solution can preprocess the fluid sample or elute fluid sample from the absorber element. Or, in some preferred embodiments, when the opening of the seal cavity is not sealed by the potted element, the seal bags are pierced by the puncture component, reagent solution is released from seal bags and contacts with fluid sample or the absorber element absorbed with fluid sample.

In other embodiments, the seal cavity 402 sealable is in fluid communication with the device for holding the detecting element, or the seal cavity 402 sealable is directly in fluid communication with the detecting element. And the seal cavity 402 sealable is communicated with a detecting element 200 and sends sample to the detecting element 200 for detection.

In some embodiments of the invention, the collection cavity 700 including a split-type structure can realize sample processing and/or sample injection, in particular to quantitative sample injection. Specifically, the collection cavity consists of a first cavity 300 and a second cavity 400 which are in a flexible connection and available for position modification; in specific embodiments, the first cavity 300 can move on the second cavity 400; in more specific embodiments, the first cavity 300 and the second cavity 400 can mutually rotate. In a specific embodiment, mutually matched screw threads are respectively arranged inside the first cavity 300 and outside the second cavity 400; in this way, the first cavity and the second cavity can rotate through thread engagement, thus realizing position modification. As shown in FIGS. 1, 2 and 3, the first cavity 300 and the second cavity 400 are partly connected to each other through engagement of screw threads 304 and 401; wherein, the first cavity 300 is a hollow cylindrical structure, while the second cavity 400 is encircled by cylinders and bottom of different sizes, the large cylinder at the upside is used for connected with the first cavity, and the small cylinder part 402 at the underpart is used for receiving samples, and realizing the function of quantitative sample injection through an opening 408 sealable by way of pressurization. The junction between the first cavity and the second cavity is provided with a snap buckle structure 600 for fixing position of the first cavity and the second cavity; when it is necessary to mutually rotate the first cavity and the second cavity, the snap buckle structure 600 is removed, and then change of relative position of the second cavity can be realized. In a preferred embodiment, the opening 408 of a seal cavity 402 is a potted element. In other embodiments, the potted element is provided with an absorber element 101 for absorbing fluid sample, the seal cavity 402 is equal to or slightly larger than the absorber element 101 for sampling in size; after the absorber element 101 is positioned inside the seal cavity 402, the potted element on the absorber element (herein referring to a cylinder 108 on the collector, and sealing ring or gasket 102 on the cylinder) can seal the opening 408 of the seal cavity 402, at this time, the seal cavity 402 sealable becomes a temporarily airtight space. At this moment, the absorber element is connected with the second cavity into a whole via the potted element of the cylinder. When the second cavity and the potted element (connected into a whole) together move relative the first cavity, the potted element squeezes the absorber element down or compresses the volume of the airtight space, and simultaneously forces a portion of fluid sample in the seal cavity onto the detecting element. In some embodiments, the detecting element is connected with the potted element and the absorber element into a whole, and a channel is provided between the absorber element and the detecting element, and fluid sample in the seal cavity flows through the channel and contacts with the detecting element.

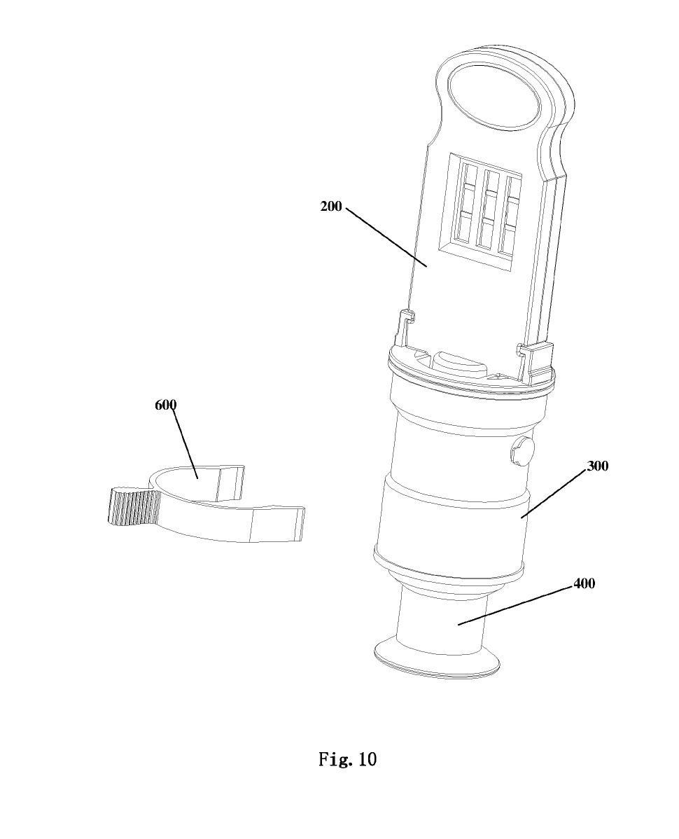

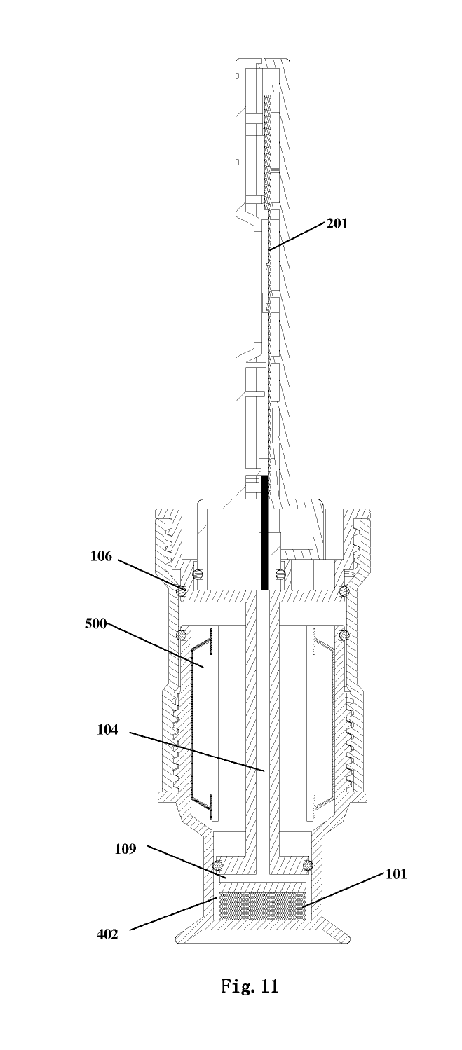

When the first cavity 300 is fixed by the snap buckle structure 600 to the second cavity 400, i.e., when the first cavity 300 is in the first position of the second cavity 400, as shown in FIG. 7, the cylinder part 402 at the underpart of the second cavity is sealed, as shown in FIG. 8. When the first cavity rotates to the second position of the second cavity, as shown in FIG. 10, the seal cavity is compressed. When the absorber element containing sample is positioned inside the seal cavity, the first cavity rotates on the second cavity, and the absorber element is compressed, and fluid sample in the seal cavity is also compressed, as shown in FIG. 11.

In addition, the collection cavity also includes a sampling mouth 301, for the convenience of resampling. In a specific embodiment, the sampling mouth 301 is positioned on the first cavity 300, and includes a plug 302 for sealing the sampling mouth.

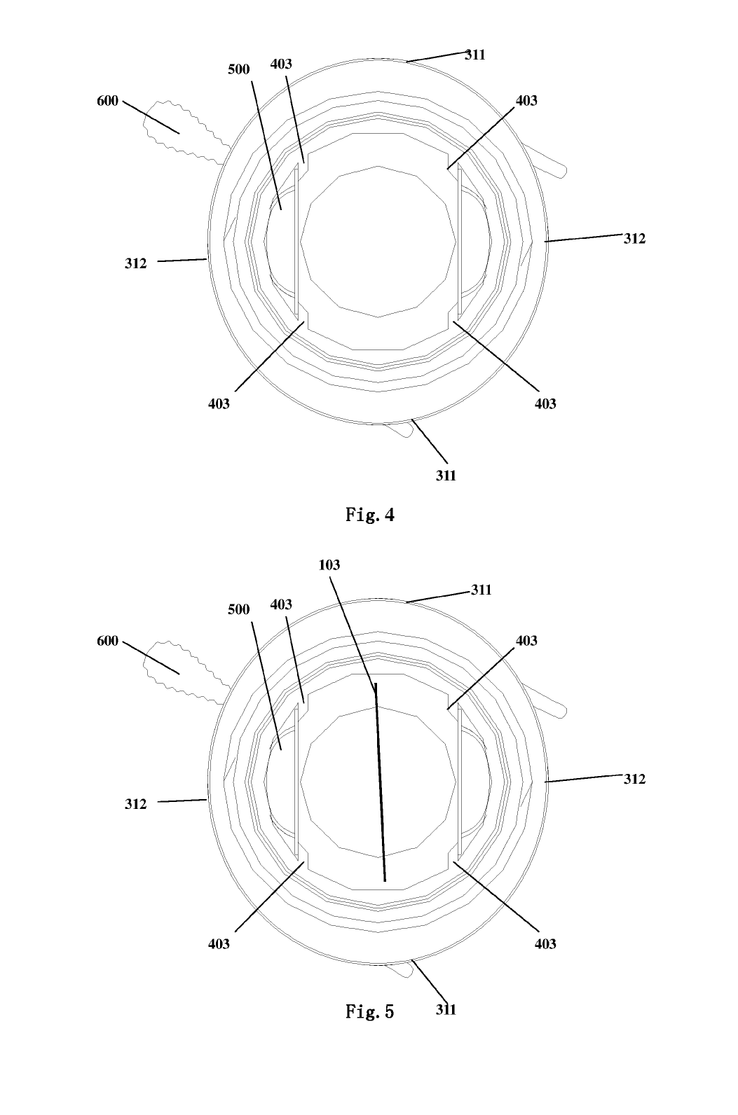

In some detection, samples shall be preprocessed, i.e., samples are blended with a solution (e.g., buffer solution). In the collection device 800 in the invention, in order to realize this function, buffer solution is filled in the collection cavity 700. In a specific embodiment, buffer solution is packaged in an aluminum foil bag 500, and the collection cavity is internally provided with a lock slot 403 for placing the aluminum foil bag. In a more specific embodiment, as shown in FIG. 2, the inside wall of the second cavity 400 is provided with four symmetrical lock slots 403, every two lock slots 403 are used for installing an aluminum foil bag 500, as shown in FIGS. 3 and 4.

In some other embodiments, for sampling, the device in the invention also includes a sample collector 100, the absorber element 101 on the sample collector is used for collecting samples (e.g., saliva and sweat, etc.), and the sample collector 100 is placed in the collection cavity 700 for collecting samples. In order to guarantee successful sample collection, operators shall be prevented from pollution. Generally, the collection cavity 700 is sealed by the sample collector 100, for example, the opening 308 on the first cavity. As shown in FIG. 1, the large cylinder 107 (the first potted element) at the upper end of the sample collector 100 is used for covering and sealing the opening 308 on the first cavity of the collection cavity 700; in order to tightly seal the collection cavity, the cylinder 107 is provided with a gasket 106 which contacts with the inside wall of the first cavity 300 and seals the first cavity. The junction between the absorber element 101 of the collector and the collection rod 104 is provided with a cylinder 108 and a sealing gasket 102 (serving as a second potted element) used for sealing the second cavity 400, thus forming a seal cavity 402. In addition, the aluminum foil bag 500 filled with buffer solution is in the second cavity 400, but at a sealed status; after entering into the collection cavity 700, samples are blended with buffer solution. In a specific embodiment, the collection rod 104 is provided with a puncture component 103 capable of piercing the aluminum foil bag. As shown in FIG. 1, the puncture component 103 is sheet-like; the height position of the puncture component 103 on the collection rod 104 is corresponding to the position of the aluminum foil bag 500 inside the second cavity after the collector 100 covers the collection cavity 700; besides, corresponding to the quantity and position of the aluminum foil bag, two puncture components 103 are symmetrically arranged on the collection rod 104. In more specific embodiments, in order to ensure the collector 100 to be inserted into the collection cavity, the sum of longitudinal length of both puncture components 103 shall be less than or equal to the diameter of the second cavity; meanwhile, in order to ensure puncture components 103 pierce the aluminum foil bag 500 inside the second cavity, the sum of longitudinal length of both symmetrical puncture components 103 shall be greater than the straight-line distance between every two lock slots 403.

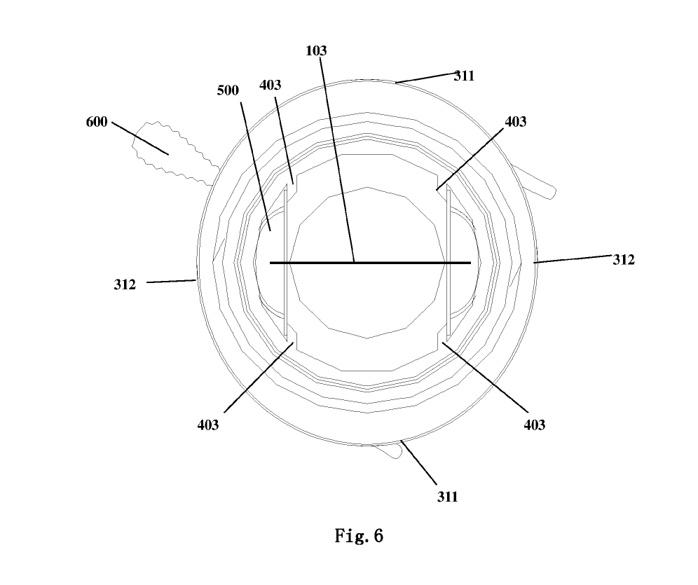

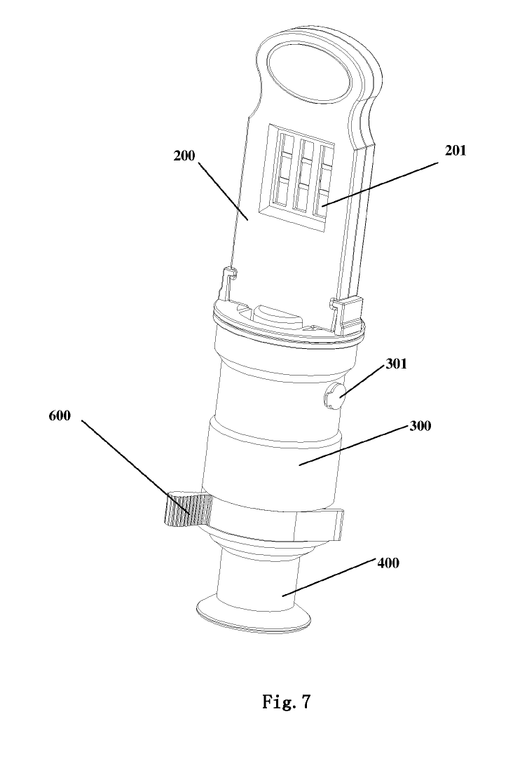

In order to ensure buffer solution to flow into the collection cavity 700 and ensure samples to be fully blended with buffer solution, the sample collector 100 has a third position 311 and a fourth position 312 (upward movement along the vertical axis relative to the first cavity and the second cavity, also can be interpreted as rotation) on the first cavity 300 of the collection cavity, as shown in FIG. 4. When the sample collector 100 is inserted into the collection cavity 700, the puncture component 103 is inserted along the third position 311; at this moment, the puncture component 103 will not pierce the aluminum foil bag 500 because the puncture component 103 is in the second cavity 400 somewhere no aluminum foil bag, as shown in FIG. 5. The collector 100 is rotated and moves in the collection cavity 700; when the sample collector 100 is in the fourth position 312 of the first cavity, the puncture component 103 contacts with and pierces the aluminum foil bag 500, as shown in FIG. 6; in other words, when the sample collector 100 is in the fourth position 312, the puncture component 103 on the sample collector is positioned within the area of the lock slot 403. More specifically, the center of the lock slot 403 on the second cavity and the fourth position 312 of the first cavity are in a straight line; thus, it can be ensured that, when the sample collector 100 is in the fourth position 312 of the first cavity, the puncture component 103 on the sample collector is just in the center of lock slots 403, i.e., the center of the aluminum foil bag 500, thus ensuring the aluminum foil bag 500 to be pierced by the puncture component 103. After the aluminum foil bag 500 is pierced, buffer solution inside flows into the collection cavity 700, and then flows onto the absorber element 101 inside the collection cavity and is blended with samples on the absorber element; at this time, as the collector is rotating in the first cavity and the second cavity, the potted element (the cylinder part 108 on the collector) had better not seal the opening 408 of the seal cavity 402.

After sample is blended with buffer solution, the sample collector 100 is rotated again to the third position 311 of the first cavity 300, so the collector drives the absorber element (including cylinders 107 and 108 and gaskets thereon) to move downward; in this way, the sample collector 100 moves downward along the second cavity so that both the opening of the first cavity 300 and the opening 408 of the seal cavity 402 in the second cavity are sealed by the sample collector 100; in other words, the cylinder 107 and the gasket 106 seal the opening of the first cavity 300; the cylinder 108 and the gasket 102 seal the second cavity 400, thus forming the seal cavity 402, as shown in FIG. 8. In this way, the sealing cylinder 108 divides fluid and reagent solution (if any) into two independent parts: one part is used for follow-up detection or other purposes, while the other part is used for follow-up detection for confirmation. In other specific embodiments, the collector 100 is in the fourth position 312 for a period of time (standing time) so that sample is fully blended with buffer solution. In an embodiment, the standing time is 1-5 minutes.

Generally, the potted element (the cylinder structure 108 on the collector) will not seal the opening 408 of the seal cavity 402 prior to elution and treatment of fluid sample on the absorber element (this needs buffer solution contacts with the absorber element). In this way, fluid sample is freely blended with buffer reagent and kept for any time for detection or other purposes. Of course, the potted element (the cylinder structure 108 on the collector) seals the opening 408 of the seal cavity 402 when buffer solution contacts with the absorber element. Once the opening 408 of the seal cavity 402 is sealed by the potted element, the second cavity is naturally divided into a seal cavity and the other cavity (i.e., the third cavity 409) in which there is a portion of fluid sample used for follow-up detection for confirmation.

In some embodiments, after the seal cavity 402 sealable is sealed by the potted element (the cylinder structure 108) on the collector 100, the relative position between the first cavity and the second cavity does not change due to limitation of the snap buckle structure, i.e., the first cavity 300 is in the first position of the second cavity 400, and the snap buckle structure 600 is positioned on the second cavity 400 or between the first cavity and the second cavity 400, as shown in FIGS. 7 and 8. At this time, the absorber element absorbed with mixed liquor consisting of sample and buffer solution is sealed in the seal cavity 402 of the second cavity, and is not compressed. Later, as shown in FIG. 9, the snap buckle structure 600 is removed from the collection cavity 700; and then the first cavity 300 is rotated downward along the second cavity 400; as the collector 100 is covered on, sealed with and fixed to the first cavity 300, the collector 100 moves together with the first cavity 300 along the second cavity 400 downward to the second position; as the second cavity is sealed by the cylinder 107 on the absorber element and by the gasket 102, both the cylinder and the gasket moves downward together with the collector 100 so that the volume of the seal cavity 402 is gradually reduced and the absorber element 101 in the seal cavity 402 is also compressed, and mixed liquid flows into the seal cavity, as shown in FIGS. 10 and 11.

Fluid sealed in the seal cavity can also be used as the sample of analytes for follow-up detection, while fluid sample (if any) outside the seal cavity can be used as sample for follow-up detection for confirmation. In other embodiments, the device 800 for collecting samples also includes a detecting element 200; while being collected, sample is injected onto the detecting element 200 for detection, thus realizing the integration of sample collection and detection. As shown in FIG. 1, in a specific embodiment, the detecting element 200 is connected to the sample collector 100, and the detecting element internally includes a test strip 201 used for testing. In order to ensure sample flows onto the detecting element 200, the sample collector 100 is in fluid communication with the detecting element 200. In an embodiment, the collection rod 104 of the sample collector is hollow, one end of which is communicated with the detecting element 200, while the other end is communicated with the absorber element 101, and communicated with a through hole 109 on the cylinder 108. After the collector 100 provided with the detecting element 200 is inserted into the collection cavity 700, the detecting element 200 is communicated with the seal cavity 402 through the hollow collection rod 104, the absorber element 101 and the through hole 109. Therefore, when the first cavity 300 rotates from the first position to the second position on the second cavity 400, the absorber element 101 is compressed as the volume of the seal cavity 402 is reduced, and mixed liquid on the absorber element 101 flows into the seal cavity 402; after the volume of the seal cavity 402 is continued to be reduced, mixed liquid in the seal cavity 402 flows into the hollow collection rod 104 through the clearance of the absorber element 101 and the through hole 109, and finally flows onto the test strip 201 inside the detecting element 200, thus completing the detection. When the first cavity 300 rotates to the second position, the size of the seal cavity 402 does not change anymore, and fluid in the seal cavity 402 does not flow into the hollow collection rod 104 anymore; the amount of fluid flowing into the detecting element 200 is in direct proportion to the degree of compression of the seal cavity 402; besides, the amount of compression of the seal cavity is fixed because the distance between the first position and the second position is fixed, thus ensuring that the amount of fluid flowing into the detecting element is fixed, thus finally realizing the function of quantitative sample injection.

A detailed description is made as below concerning specific operation process of the collection device in the invention. Firstly, the experimenter's sample is collected by the absorber element 101 of the sample collector 100 provided with the detecting element 200, after sample collection, the puncture component 103 of the sample collector is aimed at the third position 311 of the first cavity 300 (collection cavity) and inserted into the collection cavity 700; at this moment, two puncture components 103 on the collection rod 104 are in the collection cavity somewhere no aluminum foil bag. The sample collector 100 is rotated from the third position 311 to the fourth position 312 and stops; in the process of rotation, the puncture component 103 gradually contacts with an aluminum foil bag 500 placed in the lock slots 403 of the second cavity and presses against the aluminum foil bag, and later pierces the aluminum foil bag; buffer solution in the aluminum foil bag flows into the second cavity 400, flows along the sidewall of the second cavity 400 onto the absorber element 101, and blends with sample. After 1 minute, the sample collector 100 is rotated again to the third position 311, at this moment, both the first cavity 300 and the second cavity 400 are sealed by the sample collector 100, simultaneously, the collector 100 is covered on and fixed to the first cavity 300. Then, the snap buckle structure 600 is removed from outside of the collection cavity, the first cavity 300 is rotated so that the first cavity 300 moves on the second cavity 400 until the second cavity reaches the second position, as shown in FIG. 10; when the first cavity 300 is moving on the second cavity 400, the collector 100 also moves toward the second cavity 400, thus compressing the seal cavity 402 and the absorber element 101 inside, as shown in FIG. 11; in this way, quantitative mixed sample flows on the detecting element 200 through the channel, thus completing the detection.

In the absence of restrictions and any element disclosed in this text, it is possible to realize the invention in this this text. Terms and expressions are used for illustration rather than restriction; and these terms and expressions in use are not expected to exclude characteristics showed or stated or any equivalent; and it shall be realized that any modification within the scope of the invention is feasible. It shall be understood that, although the invention is disclosed by embodiments and optional characteristics, alteration and modification of concepts mentioned in the paper shall be adopted by those of ordinary skill in the art; and the alteration and modification shall be within the scope of the invention limited in claims attached.

Articles narrated or recorded in this text, patents, patent applications and all other documents and information electronically available are included to some extent in the text herein for reference, just like each individual publication specifically or separately specified for reference. The applicant reserves the rights to integrate any article, patent, patent application or any or all material and information from other documents into this application.

1. A device for detecting substances analyzed in fluid sample, wherein the device comprising: a first cavity and a second cavity, wherein the first cavity and the second cavity are in a flexible connection; liquid is stored in the second cavity through motion of the relative position of the first cavity and the second cavity.

2. The device according to claim 1, wherein the fluid is quantificationally stored in the second cavity.

3. The device according to claim 1, wherein the first cavity and the second cavity have a first position and a second position; when the first cavity and the second cavity are in the first position, the relative position of the first cavity and the second cavity is a stationary and immovable.

4. The device according to claim 3, wherein when the first cavity and the second cavity are in the second position or after the first cavity and the second cavity are released from the stationary and immovable mode, the relative position of the first cavity and the second cavity can be movable.

5. The device according to claim 3, wherein the second cavity comprising a seal chamber that can be sealed by a potted element; when the first cavity and the second cavity are in the first position, the opening of the seal chamber can be sealed by the potted element, thus forming a seal cavity.

6. The device according to claim 5, wherein when the first cavity and the second cavity move from the first position to the second position, the volume of the seal cavity is reduced.

7. The device according to claim 2, wherein when in the first position, the first cavity and the second cavity are relatively stationary and immovable by way of snap buckle structure.

8. The device according to claim 7, wherein the snap buckle structure is removed when the first cavity and the second cavity move from the first position to the second position, or only after the snap buckle structure is removed can the first cavity move from the first position to the second position, or the distance from the first position to the second position is restricted by the snap buckle structure, or the distance moving from the first position to the second position is limited by the snap buckle structure.

9. The device according to claim 6, wherein the potted element compresses the seal chamber, thus reducing its volume.

10. The device according to claim 9, wherein the potted element also comprising an absorber element connected with the potted element into a whole and used for absorbing fluid samples.

11. The device according to claim 10, wherein when the first cavity and the second cavity is in the first position, the absorber element is positioned in the seal chamber that can be sealed.

12. The device according to claim 11, wherein when the first cavity and the second cavity move from the first position to the second position, the potted element moves together with the absorber element and compresses the absorber element.

13. The device according to claim 1, wherein the first cavity or the second cavity internally comprising a solution reagent bag structure pierceable.

14. The device of claim 13, wherein the potted element comprising a puncture component which can pierce the bag structure from which solution reagent is released.

15. The device according to claim 14, wherein the second cavity is internally provided with symmetrical lock slots for placing the bag structure filled with solution reagent.

16. The device according to claim 1, wherein the potted element also comprising a detecting element which is communicated with absorber element fluid through a channel.

17. The device according to claim 16, wherein the channel is positioned in a collection rod, and the puncture component is positioned on part of the collection rod between the detecting element and the absorber element.

18. The device according to claim 15, wherein before the potted element seals the seal cavity, the puncture component positioned on the collection rod has pierced the bag structure.

19. The device according to claim 16, wherein when the first cavity and the second cavity move from the first position to the second position, a part of fluid samples in the seal cavity is forced to pass through the channel and contact with the detecting element.

20. The device according to claim 1, wherein the first cavity is connected with the second cavity through a screw thread.

21. A method, comprising: to provide a device, the device comprising a first cavity and a second cavity, wherein the first cavity and the second cavity are in a flexible connection; liquid is stored in the second cavity through motion of the relative position of the first cavity and the second cavity.

22. The method according to claim 21, wherein the first cavity and the second cavity have a first position and a second position; when the first cavity and the second cavity are in the first position, the relative position of the first cavity and the second cavity is stationary and immovable, or the relative position of the first cavity and the second cavity is stationary and immovable when the first cavity and the second cavity are in the second position.

23. The method according to claim 21, wherein when in the first position, the first cavity and the second cavity are fixed by the snap buckle structure and immovable; or the snap buckle structure is removed when the first cavity and the second cavity move from the first position to the second position; or the distance from the first position to the second position is restricted by the snap buckle structure.

24. The method according to claim 22 or 23, wherein the second cavity comprising a seal chamber that can be sealed by a potted element; when the first cavity and the second cavity are in the first position, the opening of the seal chamber can be sealed by the potted element, thus forming a seal cavity.

25. The method according to claim 24, wherein the potted element also comprising an absorber element connected with the potted element into a whole and used for absorbing fluid samples.

26. The method according to claim 25, wherein when the first cavity and the second cavity are in the first position, the absorber element is positioned in the seal chamber that can be sealed.

27. The method according to claim 26, wherein when the first cavity and the second cavity move from the first position to the second position, the potted element moves together with the absorber element and compresses the absorber element.

28. The method according to claim 21, wherein the first cavity or the second cavity internally comprising a solution reagent bag structure pierceable, the puncture component on the potted element pierces the solution reagent bag structure when the absorber element is inserted to the seal chamber.

29. The method according to claim 28, wherein before the potted element seals the seal cavity, the puncture component has pierced the bag structure.

30. The method of claim 29, wherein the puncture component is positioned on a collection rod connecting the absorber element to the detecting element, and the potted element is connected to the absorber element.

31. The device according to claim 8 wherein comprising at least one or a plurality of snap buckle structures for multi-detection of fluid samples collected or different substances analyzed.

32. The device according to claim 31, wherein a plurality of snap buckle structures are arranged in sequence, and the distance restricted by each snap buckle structure is either equal or unequal.

33. The device according to claim 32, wherein the distance restricted by the snap buckle structure can represent the volume of fluid samples.
